(19) United States
(12) Patent Application Publication
(10) Pub. No.: US 2016/0077196 A1
(43) Pub. Date: Mar. 17, 2016

(54) RECEIVER SYSTEM AND METHOD FOR RECEIVER TESTING

(71) Applicant: FREESCALE SEMICONDUCTOR ,iNC., Austin, TX (US)

(72) Inventors: Bernhard DEHLINK, MUNICH (DE); Akbar GHAZINOUR, OTTOBRUNN (DE); Ralf REUTER, MUNICH (DE)

(73) Assignee: Freescale Semiconductor, Inc., Austin, TX (US)

(21) Appl. No.: 14/889,497

(22) PCT Filed: May 29, 2013
(86) PCT No.: PCT/IB2013/054439

§ 371 Date: Nov. 6, 2015

(51) Int. Cl. G01S 7/40; G01S 13/93

(52) U.S. Cl. CPC G01S 7/4052; G01S 13/931; G01S 2007/406

(57) ABSTRACT

A receiver system which may be implemented in an integrated circuit device and suitable for use in automotive radar systems such as collision avoidance systems, includes self test circuitry whereby a local oscillator test signal is generated by an on-board frequency multiplier and mixed in a down-conversion mixer with an RF test signal. The RF test signal is generated on the device by up-conversion of an externally generated low-frequency test signal with the local oscillator test signal. Baseband components may also be checked using test signals of suitable frequency divided down from the local oscillator test signal by a programmable frequency divider. This self test arrangement obviates any need for applying externally generated RF test signals to the IC device.

### FIELD OF THE INVENTION

This invention relates to a receiver system and a method for receiver testing and has particular, though not exclusive, applicability to radar receivers for vehicles.

### BACKGROUND OF THE INVENTION

Millimetre wave radio frequency (RF) systems are finding increasing application in active safety systems for vehicles such as adaptive cruise control and collision warning systems. An increasing demand for such systems has led to a corresponding interest in integrating these RF systems on silicon and/or compound semiconductor-based integrated circuits rather than using discrete components. Silicon integration provides the possibility of manufacturing larger volumes of such systems at lower cost compared with discrete component systems or system based on compound semiconductors. Millimetre wave frequencies are generally defined to be between around 30-300 GHz with 77 GHz being a typical operating frequency for an automotive radar system. A typical radar receiver generally comprises a heterodyne or homodyne receiver for down-converting the received high-frequency (RF) signal to an intermediate frequency (IF) by mixing the high-frequency signal with a locally-generated local oscillator (LO) signal. Down conversion (to frequencies of typically less than 100 MHz,) has the benefit that the signal at the intermediate frequency (or baseband) can be processed more easily.

Testing of millimetre wave systems however is difficult and expensive. Particularly in the case of systems operating at over 10 GHz, precision test fixtures and equipment have to be used which require maintenance and calibration. One known testing procedure mentioned in WO 2010007473 involves applying high-frequency probe signals to the receiver on the die to be tested and measuring the receivers response. This method is not very reliable as the high-frequency probe signals can be very sensitive to the characteristics of the transmission lines employed. An alternative known testing procedure is described in US 20120126821 which comprises a method of testing an RF integrated circuit incorporating an on-chip test circuit. High frequency test signals (greater than 10 GHz) are generated during a test mode using a voltage controlled oscillator (VCO) which is included in the on-chip test circuit. However, VCO's tend to be unstable. Reliability is a critical factor in automotive systems where a failure rate close to 0 ppm is required.

### SUMMARY OF THE INVENTION

The present invention provides a receiver system, a method for testing a receiver system, a radar system and a vehicle as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 is a simplified block diagram of a receiver system,

FIG. 2 is a schematic diagram of a receiver system incorporated in a radar system of a vehicle,

FIG. 3 is a simplified flowchart illustrating an exemplary method of testing a receiver,

FIG. 4 is a simplified block diagram of an example of a frequency multiplier circuit suitable for use with the receiver system of FIG. 1; and

FIG. 5 is a simplified block diagram of an example of a frequency multiplier circuit including a phase-locked loop and suitable for use with the receiver system of FIG. 1.

### DETAILED DESCRIPTION OF THE PREFERRED EMBODIMENTS

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

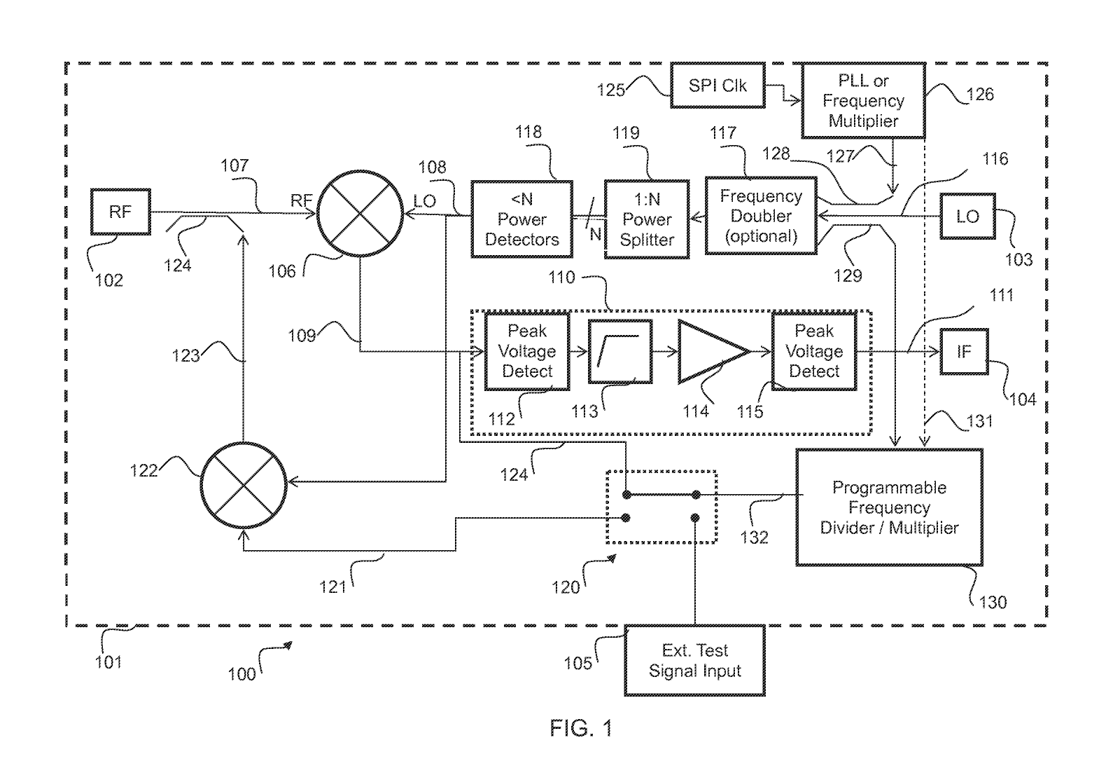

Referring now to FIG. 1 an example of a receiver system is indicated at 100 and may comprise an integrated circuit 101. The receiver system may include RF circuitry, baseband circuitry and a built in test circuitry. The receiver system in some embodiments may comprise a multichannel receiver system. In some embodiments, the integrated circuit 101 may comprise a package which may take any variety of forms such as for example, a plastic dual in-line package, ceramic dual in-line package, chip-scale package, lead-frame package or a ball grid array.

In some embodiments, the integrated circuit 101 may be implemented as a monolithic microwave integrated circuit (MMIC). In some embodiments, the integrated circuit may be fabricated using compound semiconductors, CMOS- or SiGe-BiCMOS technologies.

The integrated circuit 101 may be arranged to interface with a serial peripheral interface bus (SPI) which is asynchronous serial datalink operating in accordance with known techniques.

The integrated circuit 101 may be provided with an RF port 102, a local oscillator (LO) port 103 and intermediate frequency (IF) port 104 and a test signal port 105. The integrated circuit 101 may further comprise a down-conversion mixer 106 for mixing an RF signal received from an external source via the RF port 102 on line 107 with a local oscillator signal on line 108 down to a baseband signal on line 109. In the case where the receiver system is configured as a multichannel receiver, more than one down-conversion mixers may be provided. The down-conversion mixer may comprise any type of active or passive mixing or modulation circuitry such as for example, Gilbert type mixers, resistive mixers or diode mixers.

The output of the down-conversion mixer on line 109 may be connected to a baseband module 110 whose output on line 111 may be connected to the IF port 104. The baseband module 110 may comprise a first peak voltage detector 112, a high pass filter 113, an amplifier 114, and a second peak voltage detector 115. The first peak detector 112 may be used to measure the output voltage directly after down-conversion and also to guarantee functionality of the RF-path up to the IF signal of the down-converter 106. The second peak detector 115 may then be used to measure and track functionality of the baseband chain components comprising the high pass filter 113 , and the amplifier 114. The signal on line 111 may be taken via the IF port 104 to external circuitry for further processing.

In some embodiments, a local oscillator input line 116 may link the local oscillator port 103 with a frequency doubler 117 whose output may be fed to the LO input of the down-conversion mixer 106 on line 108 through a power detector 118. In the case of a multichannel receiver system, the output of the frequency doubler 117 may be passed through a power splitter 119 and thence a series of “N” power detectors prior to application to the LO inputs of a series of down-conversion mixers. The frequency doubler 117 may comprise any conventional circuitry for performing this function which may employ for example, phase locked loop techniques or non-linear circuits and filters.

The power detector 118 may comprise any conventional power detection circuitry or can be identical to the peak detector design used for the peak voltage detectors 112 and 115 comprising the baseband circuitry 110. Using the power detector 118, the input power level at the LO port of the down-converter 106 can be measured.

The test signal input port 105 may be operably coupled to a switch 120. An output of the switch may be operably coupled on line 121 to an input of an up-conversion mixer 122. The up-conversion mixer may be arranged to mix a signal on line 121 with a local oscillator signal on line 108 to produce an up converted signal online 123. The up-conversion mixer 122 may, for example, be a single-sideband mixer. As an alternative, a double sideband mixer may be used. In the latter case, a bandpass filter may be provided for filtering out any unwanted sideband. A second output of the switch 120 on line 124 may be operably coupled to an input of the baseband module 110. The switch may be implemented using bipolar transistors or MOS transistors or other appropriate device. The switch 120 may be controlled by dedicated signals via a SPI. In one example these may be dedicated analogue control signals generated externally to the integrated circuit 101. A first coupler 124 may be provided for coupling a signal on the output of the up-conversion mixer 122 to the RF input line 107 of the down-conversion mixer 106. The first coupler 124 may comprise any type of conventional coupling device such as a directional coupler, for example. Preferably, the coupler 124 is one having extremely low losses so that noise performance of the integrated circuit 101 is not degraded.

A SPI clock 125 provides a reference signal to a frequency multiplier module 126. An SPI clock may run typically within the range 1-100 MHz. In one embodiment, the frequency multiplier module 126 comprises a phase locked loop (PLL) configured as a frequency multiplier in accordance with conventional techniques. In an alternative embodiment, the frequency multiplier module 106 comprises a multiplied ring oscillator.

An output on line 127 from the frequency multiplier module 126 may be coupled into the local oscillator signal line 116 by means of a second coupler 128. A third coupler 129 may be provided for coupling the output of the frequency multiplier module 126 to a programmable frequency divider/multiplier module 130. The second and third couplers 128, 129 may each comprise any type of conventional coupling or power splitting device such as a directional coupler, rat race coupler, magic tee coupler. In the example where the frequency multiplier module 126 comprises a multiplied ring oscillator, an output thereof may be operably coupled to the programmable frequency divider/multiplier 130 on line 131. An output of the programmable frequency divider/multiplier on line 132 may, by the action of the switch 120, be operably coupled via line 124 to an input of the baseband module 110.

The receiver system 100 comprising the integrated circuit 101 is therefore provided with a built-in test circuitry which only requires, in one embodiment, the application of a comparatively low (5-10 MHz) externally-generated low frequency test signal at the test signal input port 105. In a manner to be described in more detail below, the low frequency test input may be up-converted (to 77 GHz in one example) to provide an RF test signal for enabling the complete RF path to be characterised and tracked. Local oscillator test signals (of 76 GHz in one typical example or 38 GHz in another example\) may be generated on-board utilising the SPI clock 125 and frequency multiplier module 126. In addition to providing a LO test signal to the down-conversion mixer 106, the local oscillator test signals may be used in the up-conversion mixer 122 to up-convert the low frequency test signal to produce an RF test signal. Further, baseband circuitry may be tested using the low frequency test signal applied via the test signal input port 105 or by switching in output signals of various frequencies from the programmable frequency divider/multiplier module 130. Signals of different frequencies may be useful for testing filter stages of the baseband module 110 for example. On-board couplers 124, 128 permit the coupling of the on-board generated test signals into the receiver RF and LO paths.

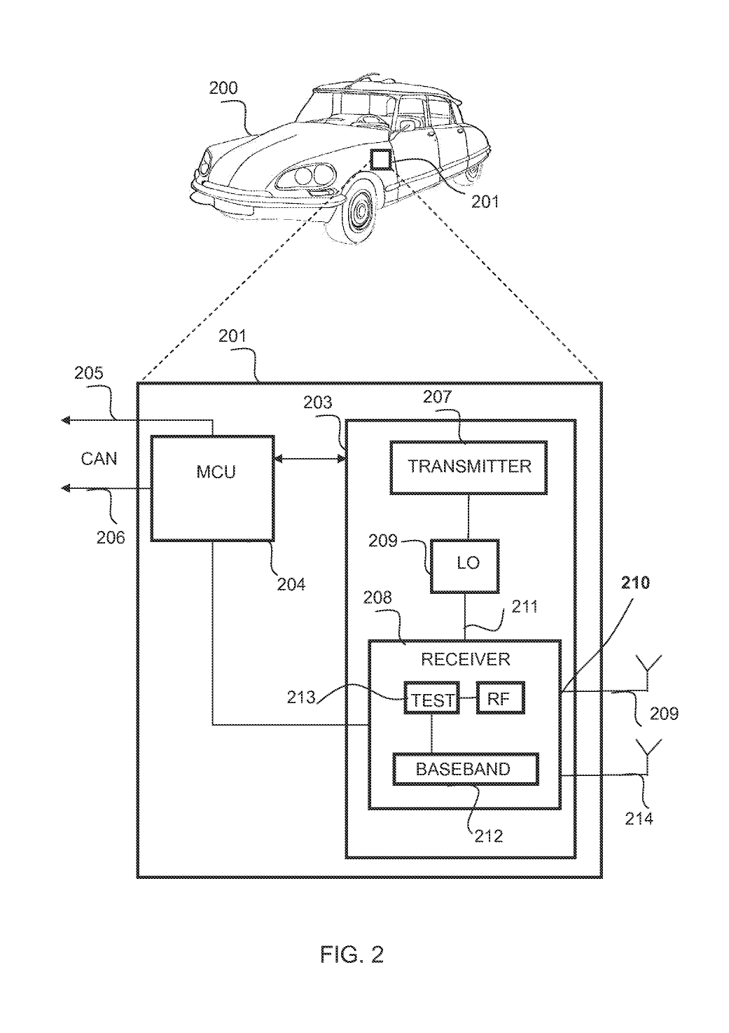

Reference will now be made to FIG. 2 where there is shown a schematic block diagram illustrating how the receiver system 100 of FIG. 1 may be implemented in a radar system of a vehicle. A vehicle 200 is fitted with a radar system 201 which, in one example, supports a collision warning system for the vehicle. Typically, in a collision warning system, electromagnetic waves of 77 GHz which are transmitted by the radar system may be reflected from objects ahead, to the side or to the rear of the vehicle 200. Reflected signals which are received by the radar system may be used to detect objects in the vicinity of the vehicle and to trigger a warning of an imminent collision. In some examples, a frequency modulated continuous-wave signal is transmitted whose reflected signal from a target permits the radar system to determine range and range rate of the target. The vehicle-mounted radar system 201 is shown in schematic form in FIG. 2 and may comprise a radar front end module 203 which may be operably coupled to a microcontroller unit MCU 204. The radar front end module 203 and the MCU 204 may be powered by the vehicle's battery on line 205. The MCU 204 may be connected on an output line 206 to the vehicle's CAN bus. The radar front end module 203 may comprise a transmitter 207 and a receiver system 208 such as that described with reference to FIG. 1, for example. A local oscillator module 209 may be connected to both the transmitter module 203 and the receiver system 208. The receiver system 208 may include the RF circuitry, test circuitry and baseband circuitry as described above with reference to FIG. 1. The receiver system 208 also comprises at least one RF input port 210, a local oscillator port 211 an IF port 212 and a test signal input port 213. In some examples, the receiver system 208 may be a multichannel receiver system which receives input RF signals from one or more antennas 209, 214. An array of antennas is useful, for example, for determining of an angle of arrival of a received radar signal by comparing phase differences between signals at the antennas thereby enabling computation of an angular position of a target. The MCU 204 may provide power and control signals to the radar front end module 203. The MCU 204 may also be arranged to supply a low frequency test signal of between 5-10 MHz to the test signal input port 213 of the receiver system 208. The MCU 204 may program one of its pulse width modulated (PWM) outputs to provide the required test signal with predetermined amplitude, frequency and phase.

Referring back to FIG. 1, operation of a receiver system in a target detection mode will now be described. A 77 GHz signal is received at the RF port 102 and a local oscillator signal is received at local oscillator port 103. In this example, there is no test signal applied to the test signal input port 105 and the programmable frequency divider/multiplier 130 and the frequency multiplier module 126 may be disabled. The local oscillator signal may be set at 76 GHz (in which case the frequency doubler 117 may also be disabled) and applied to the local oscillator input of the down-conversion mixer 106 along with the received RF signal on line 107. Alternatively, the local oscillator signal may be set at 38 GHz and doubled by the frequency doubler 117 so that a 76 GHz appears at the local oscillator input of the down-conversion mixer 106. The down-conversion mixer 106, as is conventional, produces a down-converted intermediate frequency signal typically in the range from DC to 200 MHz on line 109 which is applied to the baseband module 110. The baseband module 110 may operate as follows. The high pass filter 113 may be used to typically suppress the DC signal and the flicker noise of the down-converted signal. By this, the filter 113 prevents the following gain stage provided by the amplifier 114 from compression and DC-level offset issues. The amplifier 114 may be typically designed a variable gain amplifier (VGA) whose gain may be programmable via the SPI 125 interface. Depending on the input signal level at the RF port 102, the baseband gain may be adjusted via the amplifier 114 to optimize the signal level at the IF port 104 for any following analog to digital conversion.

The resulting (analogue) baseband signal on line 111 may be fed from the IF port 104 to an external module for further processing. The further processing may include signal amplitude measurement using an analog to digital converter. The typical frequency range of the signals appearing at the IF port 104 is from DC up to 10 MHz.

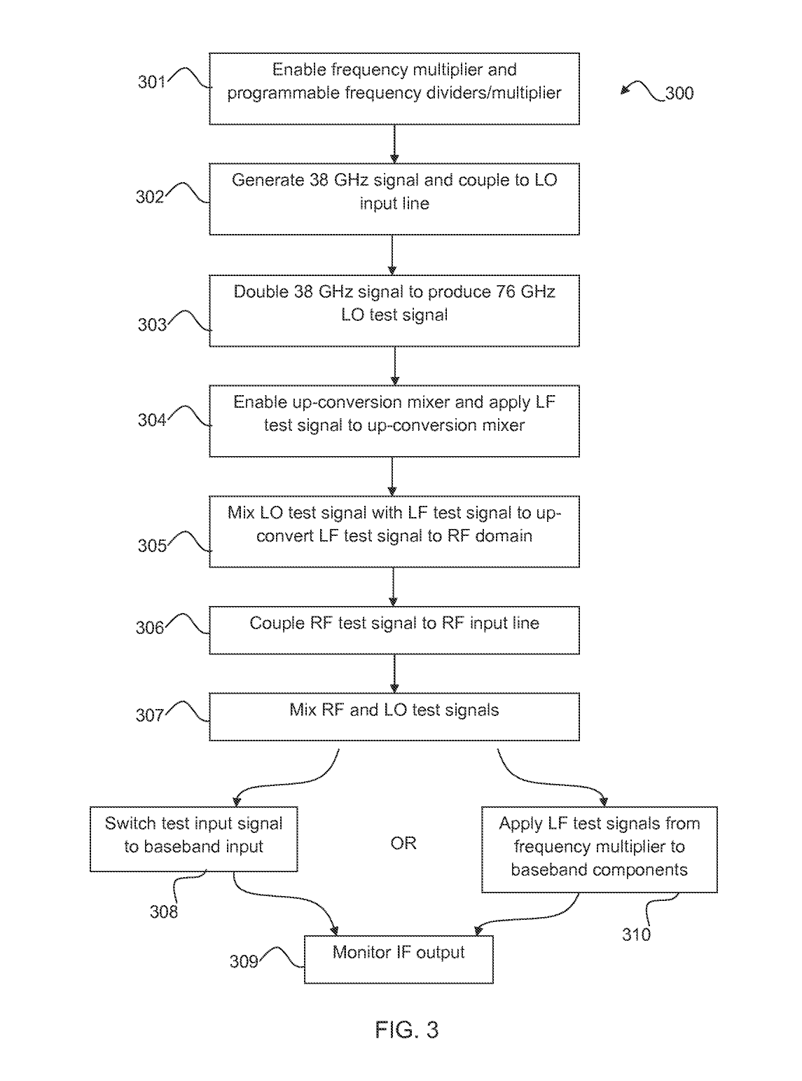

A self-test mode of operation of a receiver system will now be described with reference to FIGS. 1 and 2 and to FIG. 3 which is a simplified flowchart of a method for testing a receiver. A method 300 for testing the RF path of a receiver commences at 301 where the frequency multiplier 126 and programmable frequency divider/multiplier 130 are enabled. An enabling and programming signal may be provided by the MCU 104. At 302, a 38 GHz signal is generated in the frequency multiplier 126 and coupled by way of the second coupler 128 to the local oscillator input line 116. At 303, the 38 GHz signal is multiplied in the frequency doubler 117 to produce a 76 GHz local oscillator test signal on line 108. At 304, the up-conversion mixer 122 is enabled and a 10 MHz test signal is applied to the test signal input port 105 and the switch 120 is adjusted so that the 10 MHz test signal is applied to an input of the up-conversion mixer 122. At 305, the 76 GHz local oscillator test signal and 10 MHz test signal are mixed in the up-conversion mixer so that the 10 MHz test signal is up-converted into the RF domain to produce an RF test signal of 76 GHz+10 MHz or 76 GHz-10 MHz, for example. At 306 the RF test signal is coupled by way of the first coupler 124 to the RF input of the down-conversion mixer 106. At 307, the RF test signal is mixed with the local oscillator test signal in the down-conversion mixer 106 to produce on line 109 a baseband signal. Using a homodyne receiver architecture and with a test signal at 10 MHz, the down-conversion mixer generates a baseband signal which is identical to the test signal e.g. 10 MHz. The signal subsequently appearing at the IF port 104 may be analysed externally in order to check the operation of the RF and baseband circuitry of the receiver system.

Operation of the baseband circuitry, particularly filters and amplifiers may be checked by operating the switch 120, at 308, so that the low-frequency test signal is diverted away from the up-conversion mixer 122 and to any interface in the of the baseband chain, for example, module 110 instead. Low-frequency voltage swing measurements may then be made (at 309) at any interface between the components comprising the baseband module 110 and at the IF port 104. Measurements made at the outputs of the various baseband module components may be done by way of suitable connections or probes (not shown). As an example, signals to be measured can be taken from pads conveniently located and be converted by analogue to digital converters or read by the SPI. If any adjustments are found to be necessary as a result of the measurement and monitoring processes, a control and adjustment loop may be provided externally to the receiver. Such a loop may be implemented in a microcontroller.

An alternative method of testing baseband components at various different frequencies may be carried out by employing the frequency multiplier 126 and programmable frequency divider/multiplier 130. At 310 output signals from the frequency multiplier 126 may be coupled by way of the third coupler 129 to the programmable frequency divider/multiplier 130 which may be programmed to produce low-frequency test signals of predetermined frequencies for application to the baseband components. In some examples, the frequency range of the test signals is typically the same as the operating frequencies of the receiver IF signals.

In an alternative arrangement, the direct link 131 between the frequency multiplier 126 and the programmable frequency divider/multiplier 130 may be employed to transfer a signal of an appropriate frequency, taken from an intermediate stage of the frequency multiplication chain of the frequency multiplier 126 to the programmable frequency divider/multiplier 130.

The above method has the advantage of being able to monitor an integrated circuit receiver's functionality and performance under simulated operational conditions, that is, with a local oscillator applied. No high-frequency signals (greater than between 5-10 MHz) are required to be input to the receiver during a test procedure. All high-frequency signals are generated in the receiver itself using frequency multiplication and up conversion techniques. The above method or any part of it may be carried out on a receiver during production test or even during normal operation of the receiver. Normally, the up conversion mixer 122 is disabled. However, it is possible to enable the up-conversion mixer during normal operation and detect this (known) test signal at the IF port 104 for example.

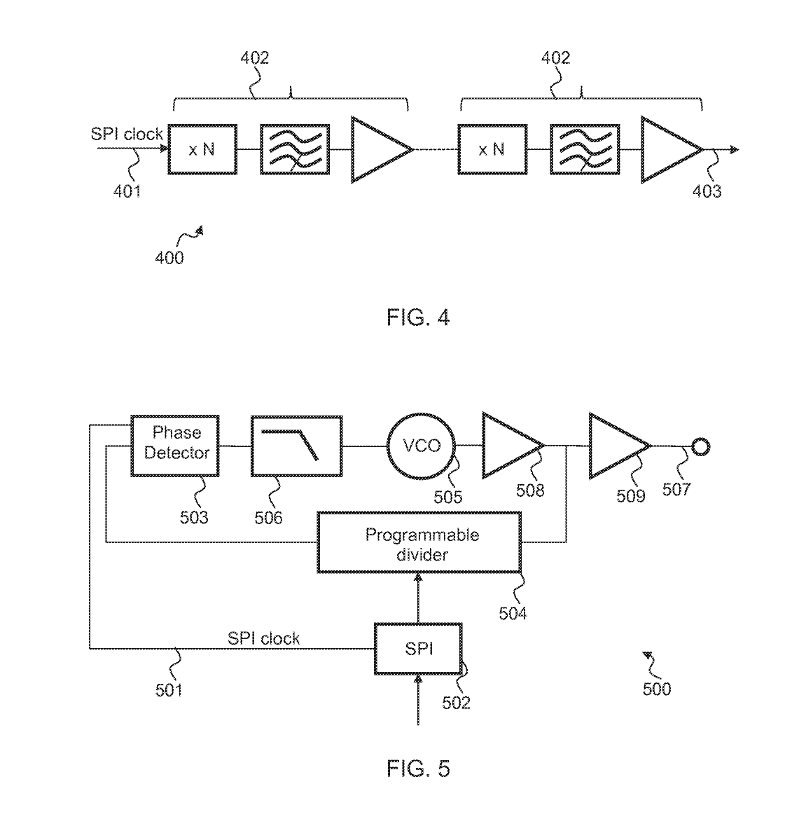

In one embodiment, the frequency multiplier 126 of FIG. 1 may comprise a non-linear circuit 400 (see FIG. 4) for generating harmonics of a reference frequency. In FIG. 4, a reference frequency may be a clock signal 401 provided by a serial peripheral interface (SPI).The frequency multiplier circuit 400 may comprise a plurality of cascaded multiplier, filter and gain stages 402 and may be based on harmonic multiplication factors, N (where N may be typically 2 or 3). Undesired frequencies may be filtered out or at least suppressed to produce a signal at a desired frequency on line 403.

In another embodiment, the frequency multiplier 126 of FIG. 1 may comprise a phase locked loop (see FIG. 5). In this example, a clock signal on line 501, supplied via a serial peripheral interface (SPI) 502, may act as a reference frequency for a phase detector 503 and may be applied to one input thereof. A programmable frequency divider 504 may comprise a part of a feedback loop between a second input of the phase detector 503 and a voltage controlled oscillator (VCO) 505. A low pass filter 506 may be operably coupled between an output of the phase detector 503 and an input of the VCO 505. The programmable frequency divider (which may be controlled by a signal on the SPI 502) acts to make the frequency of the output signal from the PLL 500 on line 507 a multiple of the reference frequency (that is, the SPI clock). One or more amplifier stages 508, 509 may be added to the output of the VCO 505.

The invention may also be implemented in a computer program for running on a computer system, at least including code portions for performing steps of a method according to the invention when run on a programmable apparatus, such as a computer system or enabling a programmable apparatus to perform functions of a device or system according to the invention.

As an example, a tangible computer program product may be provided having executable code stored therein to perform a method for testing a receiver, the method comprising, generating in the receiver a local oscillator test signal using a frequency multiplier and coupling the local oscillator test signal to a first input of a down-conversion mixer receiving a test signal at an input port of the receiver, up-converting the received test signal with the local oscillator test signal in an up-conversion mixer to produce an RF test signal, coupling the RF test signal to a second input of the down-conversion mixer, and mixing the RF test and local oscillator test signals in the down-conversion mixer to produce a baseband signal at an output port of the receiver.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, the components comprising the baseband module 110 as illustrated in FIG. 1 comprise the basic typical building blocks used in baseband circuitry. Other configurations of baseband circuitry are possible and need not necessarily be limited to the particular choice and arrangement of components illustrated, that is, peak voltage detectors, a filter and an amplifier. Further, the SPI clock 125 may be replaced with some other suitable clock generator

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Further, the entire functionality of the modules shown in FIG. 1 may be implemented in an integrated circuit That is to say that a receiver system may be implemented in an integrated circuit. Such an integrated circuit may be a package containing one or more dies. Alternatively, the examples may be implemented as any number of separate integrated circuits or separate devices interconnected with each other in a suitable manner. For example an integrated circuit device may comprise one or more dies in a single package with electronic components provided on the dies that form the modules and which are connectable to other components outside the package through suitable connections such as pins of the package and bondwires between the pins and the dies.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

1. A receiver system comprising:
a down-conversion mixer;
a frequency multiplier configured to generate a local oscillator test signal;
a first coupler configured to couple the local oscillator test signal to a first input of the down-conversion mixer;
an input port configured to receive a test signal;
an up-conversion mixer configured to mix the received test signal with the local oscillator test signal to produce an RF test signal;
a second coupler configured to couple the RF test signal to a second input of the down-conversion mixer; and
an output port configured to receive a baseband signal from an output of the down-conversion mixer.

2. The receiver system of claim 1 wherein the frequency multiplier comprises a phase-locked loop.

3. The receiver system of claim 2 wherein the phase-locked loop is configured to be driven by a SPI (serial peripheral interface) clock signal.

4. The receiver system of claim 1 wherein the frequency multiplier is configured to be driven by a SPI (serial peripheral interface) clock signal and arranged to multiply the SPI clock signal by harmonic multiplication.

5. The receiver system of claim 1 further comprising:
a baseband module arranged between an output of the down-conversion mixer and the I F output port; and
a programmable frequency divider operably coupled to the output of the frequency multiplier and configured to generate baseband test signals for applying to the baseband components.

6. The receiver system of claim 5 further comprising a switch configured to divert the received test signal to either the up-conversion mixer or to the baseband module.

7. The receiver system of claim 1 implemented in an integrated circuit

8. A method for testing a receiver, the method comprising:
generating in the receiver a local oscillator test signal using a frequency multiplier;
coupling the local oscillator test signal to a first input of a down-conversion mixer;
receiving a test signal at an input port of the receiver;
up-converting the received test signal with the local oscillator test signal in an up-conversion mixer to produce an RF test signal;
coupling the RF test signal to a second input of the down-conversion mixer; and
mixing the RF test and local oscillator test signals in the down-conversion mixer to produce a baseband signal at an output port of the receiver.

9. The method of claim 8 comprising:
dividing the local oscillator test signal to produce lower frequency test signals; and
applying said lower frequency test signals to baseband components of the receiver

10. The method of claim 9 wherein dividing the local oscillator test signal is performed in a programmable frequency divider

11. The method according to claim 8 wherein the frequency multiplier comprises a phase-locked loop.

12-15. (canceled)
